(19) United States
(12) Patent Application Publication
(10) Pub. No.: US 2026/0116830 A1
(43) Pub. Date: Apr. 30, 2026

(54) METHOD TO SET DESIRED PROPERTIES OF CURABLE BINDER COMPOSITIONS

(71) Applicant: SIKA TECHNOLOGY AG, Baar (CH)

(72) Inventors: Joachim MONGE, Paris (FR); Tristan GOUBIN, Frepillon (FR); Vincent MATHIAS, Pacy sur Eure (FR); Justine NIGAUD, Préaux (FR); Fabrice DECROIX, Croissy-sur-seine (FR)

(73) Assignee: SIKA TECHNOLOGY AG, Baar (CH)

(21) Appl. No.: 19/118,520

(22) PCT Filed: Dec. 22, 2022
(86) PCT No.: PCT/EP2022/087542

§ 371 Date: Apr. 4, 2025

(51) Int. Cl. C04B 40/00

(52) U.S. Cl. CPC C04B 40/0032

(57) ABSTRACT

A computer implemented method to determine the proportions of at least two different additives to be added to a curable binder composition, including the steps of: capturing and/or determining at least one constituent parameter, characterizing a chemical and/or physical property of at least one constituent of the curable binder composition, at least one processing parameter, characterizing a desired processing property of the composition during processing, and at least one exposure parameter, characterizing a condition the composition is intended to be exposed to in cured state; for each of the additives, deriving a proportion of the respective additive based on a predefined functional relationship, defined such that the proportion of the respective additive is calculable based on the parameters determined in step a); and making available the proportions of each of the additives derived in step b) via a user interface, via a machine interface and/or on a data storage medium.

### TECHNICAL FIELD

The invention relates to a computer-implemented method to determine the respective proportions of at least two, especially three, different additives to be added to a curable binder composition to set desired properties of the curable binder composition.

### BACKGROUND ART

In construction industry, curable binder compositions, such as e.g. mineral binder compositions, are widely used for various applications. Examples of such compositions are mortar, concrete, grout, or screed compositions.

Main constituents of curable mineral binder compositions are mineral binders, e.g. cementitious binders, optionally aggregates and water. Likewise curable organic binder compositions based on organic binders, e.g. polyurethanes and/or epoxides, can be produced. Also, it is known to provide curable binder compositions based on a mixture of mineral and organic binders.

In addition to the main constituents, additives are used in curable binder compositions to adjust physical and/or chemical properties of the curable binder composition during processing and/or in cured state. Typically, additives are liquid or powdery substances, which are added to the curable binder composition in small quantities. Nowadays, a wide range of different additives are available. Additives are for example selected from plasticizers, air entraines, defoamers, retarders, set accelerators, hardening accelerators, hydrophobising or shrinkage reducing agents and the like.

Although the use of additives allows for tailoring curable binder compositions to special requirements, selecting the right additives with appropriate dosages for a given application is a rather complex process that requires a lot of technical experience.

This is in particular true for concrete producers, such as manufacturers of ready-mix or precast concrete, that need to provide different concrete mix designs to meet different requirements for various customers and to address various applications. Typically, the design of a concrete mix takes into consideration various factors including cement type, aggregate type and ratio, water-to-cement ratio (w/c), chemical additive(s), air characteristics, placing methods, and/or numerous other factors.

In this regard, US 2020/0402619 A1 (Verifi LLC) discloses for example a method for managing the mix design catalog of a concrete producer, based on identifying clusters of slump curve data obtained during in transit concrete delivery monitoring of individual concrete loads made from various mix designs, and sorting each curve cluster based on selection factors as desired by the concrete producer. This facilitates the ability of a concrete producer to organize, to manage, and to select a mix design from within a highly populated concrete mix design catalog, and, ultimately, to reduce the number of mix designs required to be considered for meeting given project requirements, thus concentrating information per given mix design, eventually leading to less overdesign. Nevertheless, this approach hardly reduces the complexity of the individual mix designs.

US 2011/0320040 A1 (GR 2008 LLC) relates to a method for manufacturing of concrete, and more particularly to a method for adjusting a rheological property of concrete in a ready-mix truck or stationary mixer through incremental doses of a rheology-modifying agent calculated with reference to a nominal dosage response profile. Thereby, in particular, the method for adjusting concrete rheology requires only that load size and target rheology value be selected initially rather than requiring inputs into and consultation of a lookup table of parameters such as water and hydration levels, mix components, temperature, humidity, aggregate components, and others. This approach, however, is limited to determining the amount of a single type of additive to control rheology of the concrete in processable state.

Therefore, managing mix designs as well as storing and handling numerous additives still is a big challenge, especially for mortar or concrete producers. Thus, there is still a need for new and improved solutions that overcome the aforementioned disadvantages as far as possible.

### DISCLOSURE OF THE INVENTION

It is an object of the present invention to provide improved solutions for producing curable binder compositions, especially curable mineral binder compositions, with predefined properties. Preferably, the solution should allow for providing curable compositions with desired processing properties that can withstand preselected environmental conditions. Thereby, the curable binder compositions with the widest possible range of properties and as few additives as possible should be obtainable.

Surprisingly, it was found that these objects can be achieved with the method according to independent claim 1.

Specifically, according to the invention, a computer implemented method to determine the respective proportions of at least two, especially three, different additives to be added to a curable binder composition to set desired properties of the composition is provided, the method comprising the steps of:
a) Capturing and/or determining:
   at least one constituent parameter, characterizing a chemical and/or physical property of at least one individual constituent of the curable binder composition;
at least one processing parameter, characterizing a desired processing property of the binder composition during processing; and
   at least one exposure parameter, characterizing an environmental condition the binder composition is intended to be exposed to in cured state; and
   optionally, at least one environmental parameter, characterizing environmental conditions during manufacture, transport, application and/or curing of the binder composition;
b) For each of the at least two additives, deriving a proportion of the respective additive based on a predefined functional relationship, whereby the predefined functional relationship is defined such that the concentration of the additive can be calculated based on the parameters determined in step a).
c) Making available the proportions of each of the at least two additives derived in step b) via a user interface, via a machine interface and/or on a data storage medium.

As it turned out, the inventive concept, even with a very limited number of additives, allows for providing curable compositions with desired processing properties that can withstand desired requirements in the cured state.

Nevertheless, the processing properties can be adjusted in a wide range and the compositions can be adjusted to withstand a wide variety of requirements.

Especially, there is no need for numerous additives. In contrast, two or three additives usually are sufficient to set the desired properties within ranges of interest in practice. This comes with great surprise. Up to now, it was believed that setting desired properties of curable compositions requires many of different additives.

Furthermore, due to the consideration of the at least one constituent parameter, fluctuations in the quality of the raw materials, e.g. the cements and/or aggregates, can directly be compensated in order to maintain constant properties of the binder composition during processing and in the cured state.

Also, different environmental conditions during manufacture, transport, application and/or curing of the binder composition can be directly compensated for. For example, real-time adjustment of the additives due to different temperatures at different job sites can be realized. This makes it possible to keep the properties of the curable binder compositions constant and essentially independent from environmental conditions throughout the entire process, from manufacture to processing and curing.

Without wishing to be bound by theory, it is believed that this is due to the fact that the proportions of the respective additives are derived based on predefined functional relationships in a predictable manner. This allows to adjust the proportions of the additives in a highly targeted manner and to obtain curable binder composition with desired properties and constant quality.

The concentrations determined with the inventive method can for example be provided to a user via a user interface. The user then can add the additives with the respective proportions into the curable binder composition. Also, the concentrations determined with the inventive method can directly be used to automatically control the production of the curable binder composition, e.g. the production of concrete in a concrete plant. Thereby, the concentrations determined can be transferred to automatic additive supply devices via a machine interface.

Further aspects are described below and are subject of the further independent claims. Particularly preferred embodiments are outlined throughout the description and the dependent claims.

### WAYS OF CARRYING OUT THE INVENTION

A first aspect of the present invention is directed to a computer implemented method to determine the respective proportions of at least two, especially three, different additives to be added to a curable binder composition to set desired properties of the composition, the method comprising the steps of:
a) Capturing and/or determining:
   at least one constituent parameter, characterizing a chemical and/or physical property of at least one individual constituent of the curable binder composition;
   at least one processing parameter, characterizing a desired processing property of the binder composition during processing; and
   at least one exposure parameter, characterizing an environmental condition the binder composition is intended to be exposed to in cured state;
   optionally, at least one environmental parameter, characterizing environmental conditions during manufacture, transport, application and/or curing of the binder composition;
b) For each of the at least two additives, deriving a proportion of the respective additive based on a predefined functional relationship, whereby the predefined functional relationship is defined such that the concentration of the additive can be calculated based on the parameters determined in step a).
c) Making available the proportions of each of the at least two additives derived in step b) via a user interface, via a machine interface and/or on a data storage medium.

A “curable binder” denotes a material that can undergo a chemical reaction to harden into a solid. Typically curing of a curable binder is initiated by mixing with a hardening agent, for example water, by heating, by irradiation and/or by exposure to humidity. A “curable binder composition” thus is a composition comprising at least a curable binder.

For example, the curable binder can be selected from reaction resins, mineral binders, mineral binder compositions or mixtures thereof.

Reaction resins are in particular liquid or liquefiable synthetic resins that harden into duromers by polymerization or polyaddition. For example, unsaturated polyester resins, vinyl ester resins, acrylic resins, epoxy resins, polyurethane resins and/or silicone resins can be used.

A “curable mineral binder composition” is meant to be a material, which comprises at least a mineral binder and after addition of mixing water can cure by a chemical reaction to form a solid. In particular, it contains the binder, aggregates and/or one or more additives. Aggregates may be, for example, gravel, sand (in natural and/or processed, e.g. crushed, form) and/or filler. During processing, the mineral binder composition is in particular a fluid mineral binder composition mixed with mixing water.

The term “mineral binder” refers in particular to a binder which reacts in the presence of water in a hydration reaction to form solid hydrates or hydrate phases.

This can be, for example, a hydraulic binder (e.g. cement or hydraulic lime), a latent hydraulic binder (e.g. slag), a pozzolanic binder (e.g. fly ash) or a non-hydraulic binder (e.g. gypsum or white lime).

Especially, apart from the at least two, especially three, different additives to be added to a curable binder composition to set desired properties in the inventive method, the concentrations of the other constituents of the curable binder composition preferably are predefined and kept constant during the inventive process for a given curable binder composition.

However, for different applications, job specifications and/or fluctuations in raw materials, the concentrations of the other constituents of the curable binder composition can be adjusted and the inventive method can be performed with these concentrations likewise.

In particular, the predefined functional relationships used in step b) are related to a specific mix design. The mix design is meant to be the composition of the curable binder composition with respect to all constituents except the at least two, especially three, different additives to be added to a curable binder composition to set desired properties of the curable binder composition.

Capturing and/or determining of the parameters in step a) is for example performed by manually inputting the respective data, reading in the respective data via a machine interface and/or by reading the respective data with sensors.

A sensor is to be understood in a broad sense and stands for a device capable of determining a certain parameter in step a).

A sensor in particular is chosen from (i) a sensor capable of determining a chemical and/or physical property of at least one individual constituent of the curable binder composition, and/or from (ii) a sensor capable of measuring environmental conditions during manufacture, transport, application and/or curing of the binder composition.

For example, a sensor capable of determining a chemical and/or physical property of at least one individual constituent of the curable binder composition is a particle size sensor, a particle shape sensor and/or a sensor for measuring an alkaline content.

A sensor capable of measuring environmental conditions in particular is chosen from a sensor capable of determining a temperature, humidity, solar irradiance, air pressure, wind speed, wind direction, atmospheric composition, altitude, and/or other weather parameters at the place of producing the curable binder composition, at the place during the transport of the curable binder composition, at the place of intermediate storage of the curable binder composition, and/or at the place of application of the curable binder composition.

Also, the sensor might be a traffic sensor, e.g. capable of measuring the traffic density and/or average speed of vehicles on a transport route during the transport of the curable binder composition.

Furthermore, capturing and/or determining of the parameters in step a) may be effected by reading in the respective data via a machine interface. The parameters captured and/or determined in this manner may be obtained from sensors and/or in the form of processed data, e.g. data provided online in a computer network, for example data provided on an internet website. The latter might for example be traffic data and/or weather data. Especially, in step a), at least one parameter, especially the at least one environmental parameter, is measured with a sensor and/or calculated from sensor data. Thereby, in particular, the sensor is located in a transport device of the curable binder composition, in a temporary storage place of the curable binder composition and/or in a place of application of the curable binder composition.

Especially for manually inputting data, a user interface that queries at least one parameter, especially all of the parameters, may be provided. In this case, in step a), the parameter(s) can be captured via a user interface, especially via a graphical user interface.

Thereby, in particular, the user interface is configured such that for at least one parameter, especially for all parameters, a predefined list of selectable parameters is presented to a user.

Especially, in step a) inputting data is restricted to parameters compatible with the given mix design of the curable binder composition. This can for example be achieved by rejecting parameters that are incompatible and/or by restricting the list of selectable parameters to compatible parameters.

In particular, each of the at least two additives is associated with its own functional relationship. This allows for deriving the proportions of each additive in step b) separately.

According to a preferred embodiment, in step b) the functional relationship for each additive is selected form a list of different predefined multivariable functions with at least two variables, whereby the selection of the functional relationship is made depending on the at least one exposure parameter; and the at least one constituent characteristic and the at least one processing parameter, and optionally the at least one environmental parameter, are used as the variables in the selected multivariable function to calculate the respective additive concentration. Put differently, in this case the exposure parameter defines which functional relationship is to be used in step c).

Especially, the at least one constituent parameter, the at least one environmental parameter, the at least one processing parameter and/or the at least one exposure parameter each are represented by a numerical value. Nevertheless, a parameter may be captured in the form of a string and/or a symbol and later assigned a numerical value. This will in particular facilitate the manual capturing of the respective parameters for users.

Preferably, the functional relationship is based on a linear combination of (i) the at least one constituent parameter, (ii) the at least one processing parameter, and optionally (iii) the product of the at least one constituent parameter and the at least one processing parameter and/or the at least one environmental parameter. A linear combination is meant to be an expression constructed from a set of terms by multiplying each term by a constant and adding the results. Such relationships turned out to be highly suitable for determining the concentrations of the additives from the parameters considered.

Especially the functional relationship is defined as follows:

$${c}_{i} = {c}_{0} + {a}_{i} \cdot CP + {b}_{i} \cdot PP and / or$$

$${c}_{i} = {c}_{0} + {a}_{i} \cdot CP + {b}_{i} \cdot PP + {c}_{i} \cdot CP \cdot PP and / or$$

$${c}_{i} = {c}_{0} + {a}_{i} \cdot CP + {b}_{i} \cdot PP + {d}_{i} \cdot ENP and / or$$

$${c}_{i} = {c}_{0} + {a}_{i} \cdot CP + {b}_{i} \cdot PP + {c}_{i} \cdot CP \cdot PP + {d}_{i} \cdot ENP$$

with cᵢ=proportion of i-th additive, whereby i=1, 2, 3, . . . ; c₀=constant value; aᵢ, bᵢ, cᵢ, dᵢ=coefficients of linear combination; CP=constituent parameter represented by a numerical value; PP=processing parameter represented by a numerical value; ENP=environmental parameter represented by a numerical value.

However, other functional relationships may be used as well.

In particular, before step a) the functional relationship is obtained, especially with a regression analysis. The functional relationships, especially constants of the functional relationships, are in particular obtained by performing a regression analysis on a set of data points comprising proportion of additives and the at least one constituent parameter, and optionally the at least one environmental parameter, as independent variables and measured processing and exposure parameters as dependent variables.

However, other approaches for determining the functional relationships can be used as well, e.g. machine learning approaches.

Especially, the at least one constituent parameter characterizes:
a type of cement used in the curable binder composition, especially the type of cement according to DIN EN 197-1:2011, ASTM C150, or CSA A3000-08, in particular selected from types CEM I, CEM II, CEM III, CEM IV, CEM V or CEM VI; and/or
the alkaline content of the binder, especially the cement, used in the curable binder composition; and/or
a particle shape and/or size of the aggregates used in the curable binder composition, especially the shape is selected from round or crushed.

These constituent parameters often have a significant impact on processing and/or durability of curable binder compositions, especially curable mineral binder compositions. However, alternatively or in addition, other constituent parameters might be considered as well.

The at least one desired processing parameter in particular is selected from rheological properties. Especially, the at least one desired processing parameter reflects the desired consistency of the curable binder composition, especially the desired slump class, compaction class, flow class or slump-flow class, according to DIN EN 206:2021. However, alternatively or in addition, other processing parameters might be considered as well.

In particular, the at least one desired exposure parameter reflects the desired exposure class according to DIN EN 206:2021, especially selected from class XO, XC1, XC2, XC3, XC4, XS1, XS2, XS3, XD1, XD2, XD3, XF1, XF2, XF3, XF4, XA1, XA2, XA3. However, alternatively or in addition, other exposure parameters might be considered as well.

The at least one environmental parameter in particular reflects the temperature, humidity, solar irradiance, air pressure, wind speed, wind direction, atmospheric composition, altitude, and/or other weather parameters at the place of producing the curable binder composition, at the place during the transport of the curable binder composition, at the place of intermediate storage of the curable binder composition, and/or at the place of application of the curable binder composition.

Also, the at least one environmental parameter can reflect the time between production and application the curable binder composition, the time of transport of the curable binder composition, the time of intermediate storage of the curable binder composition, and/or traffic conditions during transport of the curable binder composition, e.g. traffic density and/or average speed of vehicles on a transport route during the transport of the curable binder composition.

In particular the at least one environmental parameter at least reflects environmental conditions at the place of application of the curable binder composition, especially at a job site. Even more preferred, the at least one environmental parameter in addition reflects environmental conditions during transport and/or intermediate storage, and further preferred also during manufacturing of the curable binder composition. This ensures that the curable binder composition has the right properties for the specific conditions are the job site.

Preferably, the curable binder composition is a curable mineral binder composition, especially a curable mortar, concrete or grout composition.

The mineral binder comprised in the curable mineral binder composition is preferably selected from the group consisting of cement, gypsum, burnt lime, slag, and fly ash, and mixtures thereof. The curable mineral binder composition preferably comprises at least one hydraulic binder, preferably a cementitious binder.

The hydraulic binder is preferably selected from the group consisting of Portland cement, calcium aluminate cement, calcium sulfoaluminate cement, and mixtures thereof.

The cement used may be any available cement type or a mixture of two or more cement types, examples being the cements classified under DIN EN 197-1: Portland cement (CEM I), Portland composite cement (CEM II), blast furnace slag cement (CEM III), pozzolanic cement (CEM IV), and composite cement (CEM V).

Cements produced according to an alternative standard, such as the ASTM standard or the Indian standard, for example, are of course equally suitable.

Particularly preferred is a cement according to DIN EN 197-1, a calcium sulfoaluminate cement, a calcium aluminate cement, or mixtures thereof, optionally in a mixture with calcium sulfate.

The most preferred is Portland cement or a cement including Portland cement according to DIN EN 197-1. Portland cement is particularly readily available and allows mortars to have good properties.

Also especially suitable are mixtures of Portland cement, calcium aluminate cement, and calcium sulfate, or mixtures of cement and calcium sulfoaluminate cement. Such binder mixtures allow short setting times and high early strengths.

The curable composition preferably further comprises aggregates, especially mineral aggregates. Aggregates are chemically inert, solid, particulate materials and are available in various shapes, sizes and as different materials, varying from extremely fine particles of sand to large coarse stones. All aggregates typically employed for concrete and mortar are suitable in principle.

Examples of particularly suitable fillers are rock particle size fractions, gravel, sand, especially silica sand and limestone sand, comminuted stones, calcined pebbles or lightweight fillers such as expanded clay, expanded glass, foamed glass, pumice, perlite, and vermiculite. Other advantageous aggregates are calcium carbonate, aluminum oxide, amorphous silica (silica fume), or crystalline silica (quartz flour).

In particular, the at least two, especially three, different additives are selected from: plasticizers, thickeners, air entrainers, defoamers, retarders, set accelerators, hardening accelerators, hydrophobising agents, or shrinkage reducing agents.

Especially, the number of additives to be added to the curable binder composition to set desired properties is limited to two, three or four different additives. In particular, there are three different additives.

In particular, there are three different additives comprising: a plasticizer, a retarder and an air entrainer.

Examples of suitable plasticizers include lignosulfonates, sulfonated naphthalene-formaldehyde condensates, sulfonated melamine-formaldehyde condensates, sulfonated vinylcopolymers, polyalkylene glycols having phosphonate groups, polyalkylene glycols having phosphate groups, polycarboxylates or polycarboxylate ethers, or mixtures of the stated plasticizers; polycarboxylate ethers are understood to comprise comb polymers having anionic groups on the polymer backbone and having polyalkylene oxide side chains, the anionic groups being selected in particular from carboxylate groups, sulfonate groups, phosphonate groups, or phosphate groups.

For example, retarders are selected from lignosulphonates, hydroxycarboxylic acids and their salts, phosphonates, sugars and sugar derivatives, and/or borates.

The air entraining agent is e.g. selected from surfactants, resin soaps or mixtures thereof, wherein the air entrainment agent is preferably a surfactant. As rosin soaps, in particular, soaps of natural resins, e.g. tall oil, gum rosin or wood rosin, as well as derivatives thereof, e.g. maleic acid adducts, are suitable. The resin soaps may be obtained by saponification of the natural resins with bases such as e.g. alkali hydroxides are produced. The surfactant may e.g. an anionic, cationic, nonionic, amphoteric or zwitterionic surfactant or a mixture of these surfactants. A variety of surfactants of different structural types are known for use as air entraining agents and are commercially available.

The inventive method can in principle be performed on any kind of computer device and/or control unit.

According to a special embodiment, the method is performed on a mobile computer device. In the present context, a mobile computer device in particular is meant to be a handheld computer, i.e. a computer small enough to hold and operate in the hand of a human. Especially selected from a mobile phone, a mobile computer or a portable computer. This allows a user on a construction site to direct find the right proportions of at least two different additives for obtaining a curable binder composition with suitable properties for a given application.

In another preferred embodiment, the method is performed within a control unit of a machine that is configured for producing curable mineral binder composition, such as e.g. a mixing device for preparing ready mix mineral binder compositions and/or precast concrete, for example in a concrete plant.

Specifically, the method can be implemented in various ways, e.g. in the form of a standalone application running on the mobile device and/or the control unit of a machine without need for any further resources such as for example server systems. This is in particular helpful in areas with limited access to communication networks, e.g. far away from urban centers or underground. However, the method can be implemented as well in a distributed computing environment, e.g. comprising the mobile device and/or the control unit as a client in combination with a dedicated server as a storage unit and/or with a specialized processing unit.

Also, the inventive method can be implemented in a flexible manner with known software architectures, e.g. as native application, a progressive web application (PWA), or a hybrid application (combination of native and PWA). Thereby, helpful internet links to tutorials or support sites as well as sharing functions (e.g. via e-mail, Bluetooth, Airdrop, or others communication means) can be included in such applications as well. Also, the inventive method can be implemented in one single application or it may be divided into two or more separate applications with appropriate software interfaces for data exchange between the applications.

Furthermore, the application(s) can be extended with additional functions in a flexible manner.

Applications can be implemented for any kind of operating systems such as e.g. iOS, Android, Microsoft Windows and/or Linux.

Another aspect of the invention is related to a method for producing a curable binder composition with predefined desired properties comprising the steps of:
(i) Providing a curable binder composition, especially a mortar, concrete or grout composition,
(ii) Providing at least two, especially three, different additives to be added to the curable binder composition of step (i) to obtain the curable binder composition with desired properties;
(iii) Determining the respective proportions of at least two, especially three, different additives to be added to the curable binder composition according to the method as described above;
(iv) Adding the at least two, especially three, different additives to the curable binder composition with the proportions determined in step (iii).

Thereby, the curable binder composition and the additives are defined as described above.

The at least one constituent parameter used in step (iii) is a constituent parameter of the curable binder composition provided in step (i).

The at least one environmental parameter optionally used in step (iii) is in particular the temperature at the place of producing the curable binder composition and/or at the place of application of the curable binder composition.

In particular, the at least one constituent parameter, and optionally the at least one environmental parameter, is determined, especially by measuring, before and/or during step (i). This can e.g. be achieved by measuring the respective parameter of a constituent before mixing it with the other constituents of the curable binder composition. The at least one environmental parameter can for example be obtained with a sensor as described above.

The method can be performed as a batch process or as continuous process. Thus, steps (i) to (iv) can be performed in sequence, especially in the sequence given, or at least partly simultaneously.

Especially, in a continuous process, at least steps (i), (ii), and (iv), preferably all steps (i) to (iv), are performed continuously and preferably simultaneously. Put differently, in a continuous process a curable binder composition and the at least two, especially three, different additives are continuously provided and the latter are continuously added to the curable binder composition with the proportions determined in step (iii).

Thereby, step (iii) can be performed once or repeatedly. Repeatedly performing step (iii) has for example the advantage that fluctuations in the nature and/or quality of constituents and/or fluctuations of environmental conditions during manufacture, transport, application and/or curing of the curable binder composition can be compensated by adjusting the proportion of the at least two additives. In this case, the at least one constituent parameter and/or the at least one environmental parameter is/are repeatedly, especially continuously, determined, especially measured, during step (i).

This allows for a real time adjustment of the proportions of the at least two additives depending on at least one constituent parameter and/or the at least one environmental parameter. This is in particular beneficial when producing ready-mix compositions and/or precast concrete in a concrete plant.

Step (iv) preferably is performed in a mixing device.

Especially, in step (iv), each of the at least two, especially three, different additives are added to the curable binder composition with an individual additive supply device, in particular into the mixing device. An additive supply device comprises for example a container for the additive, a controllable valve for adding the additive to the curable binder compositions and optionally a flow meter for measuring the amount of additive added.

The addition of the additives with the individual additive supply devices preferably is automatically controlled based on the proportions of each of the at least two additives determined in step (iii). However, manual control of the supply devices is possible as well.

In particular, the method is performed for producing ready-mix concrete and/or precast concrete, especially in a concrete plant.

A further aspect of the present invention is related to a method for producing a curable binder composition with predefined desired properties, especially a curable mortar, concrete or grout composition, in particular a ready-mix concrete, whereby the method is in particular performed in a concrete plant, comprising the steps of:
(i) Providing the curable binder composition, especially a mortar, concrete or grout composition;
(ii) Providing at least two, especially three, different additives;
(iii) Determining the respective proportions of the at least two, especially three, different additives to be added to the curable binder composition to set the desired properties of the curable binder composition, with a computer implemented method, the method comprising the steps of:
   a) Capturing and/or determining:
      at least one constituent parameter, characterizing a chemical and/or physical property of at least one individual constituent of the curable binder composition;
      at least one processing parameter, characterizing a desired processing property of the binder composition during processing; and
      at least one exposure parameter, characterizing a condition the binder composition is intended to be exposed to in cured state; and
      optionally, at least one environmental parameter, characterizing environmental conditions during manufacture, transport, application and/or curing of the binder composition;
   b) For each of the at least two additives, deriving a proportion of the respective additive based on a predefined functional relationship, whereby the predefined functional relationship is defined such that the proportion of the respective additive is calculable based on the parameters determined in step a).
   c) Making available the proportions of each of the at least two additives derived in step b) via a user interface, via a machine interface and/or on a data storage medium.
(iv) Adding the at least two, especially three, different additives of step (ii) to the curable binder composition of step (i) with the proportions determined in step (iii).

All embodiments described as above also relate to this aspect.

A further aspect of the present invention a computer program or a computer-readable medium comprising instructions which, when executed by a computer device, cause the computer device to carry out the methods as described above.

Another aspect is related to a system comprising a computer device whereby the system is configured for performing a method as described above. Especially the system is a control unit of a concrete plant.

Further advantageous implementations of the invention are evident from the exemplary embodiments.

### BRIEF DESCRIPTION OF THE DRAWINGS

The drawings used to explain the embodiments show:

FIG. 1 a flow diagram of an inventive computer implemented method to determine the respective proportions of two or three different additives to be added to a curable binder composition, e.g. a concrete composition, to set desired properties of the curable binder composition;

FIG. 2 a schematic view of a device for producing a curable binder composition, e.g. a concrete composition, with the inventive method;

FIG. 3a, b the user interface of a computer program running on a mobile computer device that implements the inventive method.

### EXEMPLARY EMBODIMENTS

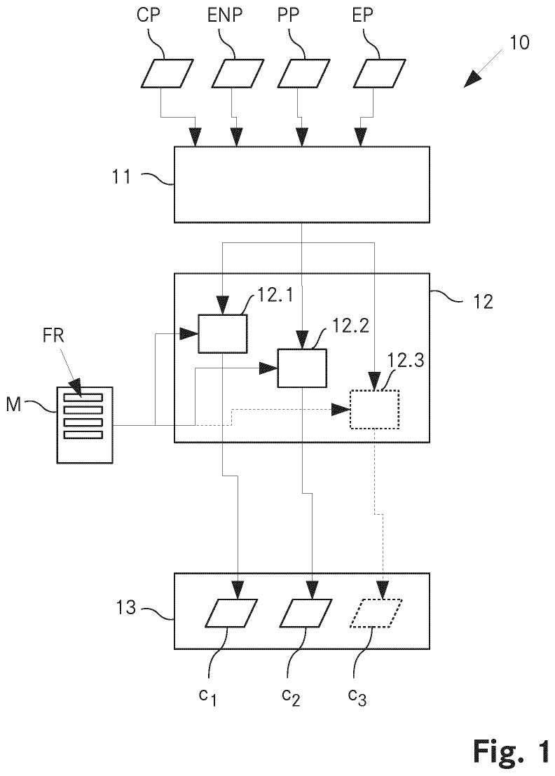

FIG. 1 shows a flow diagram of an inventive computer implemented method 10 to determine the respective proportions of two or three different additives to be added to a curable binder composition, e.g. a concrete composition, to set desired properties of the curable binder composition. Thereby, apart from the two or three different additives to be added, the curable binder composition is predefined in terms of all other components.

In a first step 11, a constituent parameter CP, an environmental parameter ENP, a processing parameter PP and an exposure parameter EP are captured, e.g. via a graphical user interface that is configured such that for all parameters a predefined list of selectable items is presented to a user.

The constituent parameter CP characterizes for example the particle shape of the aggregates (e.g. round or crushed) or the alkaline content of the binder used in the curable binder composition. The environmental parameter ENP is for example the temperature at the place of application of the curable binder composition, e.g. selected from three typical temperature ranges. The processing parameter PP slump is in particular selected from the slump class (e.g. S1, S2, S3 or S4). The exposure parameter EP may be the desired exposure class (e.g. XO, XC1, XC2, XC3, XC4, XS1, XS2, XS3, XD1, XD2, XD3, XF1, XF2, XF3, XF4, XA1, XA2, XA3). CP, ENP, PP and EP can be automatically transformed to numerical values during step 11.

In the second step 12, for each of the at least two or three additives, a proportion of the respective additive is calculated based on a predefined functional FR relationship. The predefined functional relationships FR, which have been determined in advance by testing, are for example stored in a memory unit M and are represented by formulas of type cᵢ=c₀+aᵢ·CP+bᵢ·PP+dᵢ·ENP and/or cᵢ=c₀+aᵢ·CP+bᵢ·PP+cᵢ·CP·PP+dᵢ·ENP (with cᵢ=proportion of i-th additive, whereby i=1, 2, 3, . . . ; c₀=constant value; aᵢ, bᵢ, cᵢ, dᵢ=coefficients of linear combination; CP=constituent parameter represented by a numerical value; PP=processing parameter represented by a numerical value; ENP=environmental parameter represented by a numerical value).

Specifically, in a first sub-step 12.1, the concentration c₁ of a first additive A1, e.g. a plasticizer, is calculated by selecting a predefined functional relationship based on the exposure parameter EP. By considering the constituent parameter and the processing parameter in the predefined functional relationship, the concentration of additive A1 can be calculated directly.

Likewise, the concentration c₂ of a second additive A2, e.g. a retarder, is calculated in a second sub-step 12.2 and, if used, the concentration c₃ of a third additive A3, e.g. an air-entrainer, is calculated in a third sub-step 12.3.

In a third step 13, the concentrations c₁, c₂, c₃ of the additives A1, A2 and A3 are made available, e.g. via a user interface, for example a display.

Thereafter, a user can prepare a curable binder composition with the desired processing and exposure properties, by adding the respective concentrations of the additive the curable binder composition.

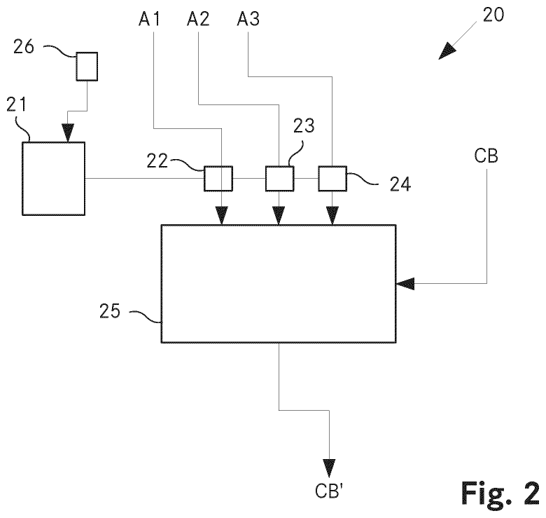

FIG. 2 shows a schematic view of a device for producing a curable binder composition, e.g. a concrete composition, with the inventive method.

A curable binder composition CB that is to be adjusted in terms of processing and exposure properties is provided in a mixing device 25 and three different additives A1, A2, A3 as described above with FIG. 1 are provided separately. Additionally, the temperature at the intended place of application of the curable binder can be measured with a remote temperature sensor 26.

Three individually controllable additive supply devices 21, 22, 23 allow to introduce controlled amounts of the additives into the mixing device 25. The proportions of the additives A1, A2, A3 to be added are calculated in a control unit 21, which is configured to perform the process of FIG. 1. In a batch processing mode, the concentrations of the additives are determined and subsequently, the respective proportions of the additives are added to and intermixed with the curable binder in the mixing device 25.

This results in a curable binder CB′ with the desired processing and exposure properties that can be taken out of the mixing device 25.

In an alternative continuous process mode, the curable binder CB and the additives A1, A2, A3 are constantly introduced into the mixing device and the modified curable binder CB′ is constantly removed from the mixing device. Thereby, the concentrations of the additives A1, A2, A3 can calculated and adjusted repeatedly based on an actual value of the constituent parameter, which in this case is measured constantly.

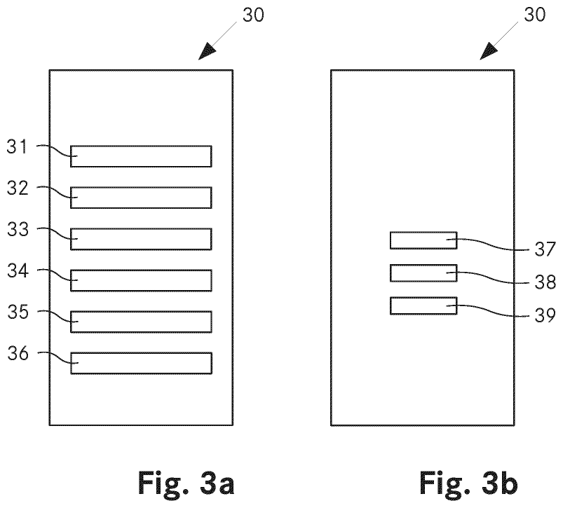

FIG. 3a shows an input mask presented on a touch screen 30 of mobile computer device. The mobile computer device runs a computer program that implements the inventive method.

A selection list 31 allows for choosing the exposure class of the concrete to be produced. The exposure class will determine, the basic concrete formulation to be used (e.g. the water to cement ratio; proportions of aggregates) and the specific predetermined functional relationships to be selected from a list of several predetermined functional relationships stored in the computer program. The selected specific predetermined functional relationships later on will be used to calculate the proportions of the three additives to be added to the basic concrete formulation.

A selection list 32 and an input field 33 allow for choosing the type of cement and to enter the alkali content of the cement, respectively. The type of cement and its alkali content usually have a strong impact on the dosage of the additives, especially the amount of superplasticizer that is needed to reach a desired consistency. The type of cement determines how the alkali content is to be considered. For example, for cements of type CEM III or CEM V the alkali content is not relevant and can be set to a constant stored in the computer program. However, for other cements, like CEM I and II, the alkali content is relevant and needs to be provided by the user (via input field 33).

A further selection list 34 allows for choosing the type of aggregates. For example, example, the selection can be made from three different types of aggregates: river, semi-crushed or crushed. Each one corresponds to a level of difficulty. The more difficult the aggregate is, the higher the dosage of the additives needs to be set to reach a desired consistency.

A selection list 35 allows for choosing the consistency of the concrete. For example, there are three options: S3 (slump between 100 and 150 mm), S4 (slump between 160 and 210 mm) and SCC (self-compacting concrete with a slump flow SF2 between 650 and 750 mm).

A selection list 36 allows for choosing the temperature of the concrete. For example, there are three different options that corresponds to three different seasons of the year (winter/mid-season/summer): 10° C., 20° C. or 30° C.

Once all the parameters are captured, the concentrations of the three additives are calculated in a manner similar as described with FIG. 1. Subsequently, the program displays the proportions of the three additives 37, 38, 39 to be added to the concrete formulation to obtain the desired consistency and exposure class on the touch screen 30, as shown in FIG. 3b.

The embodiments shown are merely examples, which can be modified as desired within the scope of the invention.

For example, instead of or in addition to the temperature, traffic conditions during transport of the curable binder composition to a job site, e.g. traffic density and/or average speed of vehicles on a transport route during the transport of the curable binder CB′, can be obtained online via a traffic website and can be considered as the environmental parameter ENP or as a further environmental parameter ENP′.

Likewise, in the example of FIG. 3, one or more of the parameters, e.g. the type of cement and/or the type of the aggregates can be directly obtained via a machine interface from a network device without need to be provided by the user.

1. A computer implemented method to determine the respective proportions of at least two different additives to be added to a curable binder composition to set desired properties of the curable binder composition, the method comprising the steps of:
a) capturing and/or determining:
at least one constituent parameter, characterizing a chemical and/or physical property of at least one individual constituent of the curable binder composition;
at least one processing parameter, characterizing a desired processing property of the binder composition during processing; and
at least one exposure parameter, characterizing a condition the binder composition is intended to be exposed to in cured state; and
optionally, at least one environmental parameter, characterizing environmental conditions during manufacture, transport, application and/or curing of the binder composition;
b) for each of the at least two additives, deriving a proportion of the respective additive based on a predefined functional relationship, whereby the predefined functional relationship is defined such that the proportion of the respective additive is calculable based on the parameters determined in step a).
c) making available the proportions of each of the at least two additives derived in step b) via a user interface, via a machine interface and/or on a data storage medium.

2. The method according to claim 1, whereby in step b):
the functional relationship is selected form a list of different predefined multivariable functions with at least two variables, whereby the selection of the functional relationship is made depending on the at least one exposure parameter; and
the at least one constituent parameter and the at least one processing parameter, and optionally the at least one environmental parameter, are used as the variables in the selected multivariable function to calculate the respective additive concentration.

3. The method according to claim 1, whereby the functional relationship is based on a linear combination of (i) the at least one constituent parameter, (ii) the at least one processing parameter, and optionally (iii) the product of the at least one constituent parameter and the at least one processing parameter and/or the at least one environmental parameter.

4. The method according to claim 1 whereby before step a) the functional relationship is obtained, wherein, the functional relationships, are obtained by performing a regression analysis on a set of data points comprising proportion of additives and the at least one constituent parameter, and optionally the at least one environmental parameter, as independent variables and measured processing and exposure parameters as dependent variables.

5. The method according to claim 1, whereby the at least one constituent parameter characterizes:
the type of cement used in the curable binder composition; and/or
the alkaline content of the binder used in the curable binder composition; and/or
a particle shape and/or particle size of the aggregates used in the curable binder composition.

6. The method according to claim 1, whereby the at least one processing parameter reflects the desired consistency of the curable binder composition.

7. The method according to claim 1, whereby the at least one desired exposure parameter reflects the desired exposure class according to DIN EN 206:2021.

8. The method according to claim 1, whereby the at least one environmental parameter reflects the temperature, humidity, solar irradiance, air pressure, wind speed, wind direction, atmospheric composition, altitude, and/or other weather parameters at the place of producing the curable binder composition, at the place during the transport of the curable binder composition, at the place of intermediate storage of the curable binder composition, and/or at the place of application of the curable binder composition, and/or whereby the at least one environmental parameter reflects the time between production and application the curable binder composition, the time of transport of the curable binder composition, the time of intermediate storage time of the curable binder composition, and/or traffic conditions during transport of the curable binder composition.

9. The method according to claim 1, whereby in step a), at least one parameter is captured via a user interface, whereby the user interface is configured such that for at least one parameter, a predefined list of selectable parameters is presented to a user.

10. The method according to claim 1, whereby in step a), at least one parameter is measured with a sensor and/or calculated from sensor data.

11. The method according to claim 1, whereby the method is performed on a mobile computer device.

12. A method for producing a curable binder composition with predefined desired properties comprising the steps of:
(i) providing a curable binder composition;
(ii) providing at least two different additives to be added to the curable binder composition of step (i) to obtain the curable binder composition with desired properties;
(iii) determining the respective proportions of at least two different additives to be added to the curable binder composition according to the method as described in claim 1;
(iv) adding the at least two different additives to the curable binder composition with the proportions determined in step (iii).

13. The method according to claim 1, whereby the curable binder composition is a curable mineral binder composition.

14. The method according to claim 1, whereby the at least two different additives comprise: a plasticizer, a retarder and optionally an air entrainer.

15. A method according to claim 12, for producing a curable binder composition with predefined desired properties, comprising the steps of:
(i) providing the curable binder composition;
(ii) providing at least two different additives;
(iii) determining the respective proportions of the at least two different additives to be added to the curable binder composition to set the desired properties of the curable binder composition, with a computer implemented method, the method comprising the steps of:
a) capturing and/or determining:
at least one constituent parameter, characterizing a chemical and/or physical property of at least one individual constituent of the curable binder composition;
at least one processing parameter, characterizing a desired processing property of the binder composition during processing; and
at least one exposure parameter, characterizing a condition the binder composition is intended to be exposed to in cured state; and
optionally, at least one environmental parameter, characterizing environmental conditions during manufacture, transport, application and/or curing of the binder composition;
b) for each of the at least two additives, deriving a proportion of the respective additive based on a predefined functional relationship, whereby the predefined functional relationship is defined such that the proportion of the respective additive is calculable based on the parameters determined in step a).
c) making available the proportions of each of the at least two additives derived in step b) via a user interface, via a machine interface and/or on a data storage medium.
(iv) adding the at least two different additives of step (ii) to the curable binder composition of step (i) with the proportions determined in step (iii).

16. The method according to claim 12, whereby the method is performed as a continuous process in which a curable binder composition and the at least two different additives are continuously provided and the latter are continuously added to the curable binder composition with the proportions determined in step (iii), whereby step (iii) is performed repeatedly.

17. The method according to claim 12, whereby in step (iv), each of the at least two different additives are added to the curable binder composition with an individual additive supply device and whereby the addition of the additives with the individual additive supply devices is automatically controlled based on the proportions of each of the at least two additives determined in step (iii).

18. A computer program comprising instructions which, when the program is executed by a computer, cause the computer to carry out the method of claim 1.
